(19) United States
(12) Patent Application Publication
(10) Pub. No.: US 2013/0171388 A1
(43) Pub. Date: Jul. 4, 2013

(54) PROCESS FOR PRODUCING A MOULDING FROM A POLYAMIDE MOULDING COMPOSITION WITH IMPROVED HYDROLYSIS RESISTANCE

(71) Applicants: Andreas PAWLIK, Recklinghausen (DE); Andreas DOWE, Borken (DE); Juergen FRANOSCH, Marl (DE); Harald HAEGER, Luedinghausen (DE); Franz-Erich BAUMANN, Duelmen (DE); Reinhard BEUTH, Marl (DE)

(72) Inventors: Andreas PAWLIK, Recklinghausen (DE); Andreas DOWE, Borken (DE); Juergen FRANOSCH, Marl (DE); Harald HAEGER, Luedinghausen (DE); Franz-Erich BAUMANN, Duelmen (DE); Reinhard BEUTH, Marl (DE)

(21) Appl. No.: 13/729,280

(22) Filed: Dec. 28, 2012

(30) Foreign Application Priority Data
Dec. 29, 2011 (DE) 10 2011 090 092.6

(51) Int. Cl. C08L 77/00

(52) U.S. Cl. CPC C08L 77/00
USPC 428/35.7; 525/419

(57) ABSTRACT

A process for producing hydrolysis-resistant mouldings with geometries having large dimensions by cumulative condensation of a polyamide moulding composition, is provided. The process includes mixing a polyamide moulding composition of a polyamide having at least 50% of amino end groups with 0.1 to 5% by weight, based on the polyamide moulding composition, of an oligo- or polycarbodiimide. The mixture is subsequently processed to give the moulding, wherein cumulative condensation is obtained during the processing of the moulding.

### CROSS REFERENCE TO RELATED APPLICATIONS

This application claims priority to German Patent Application No. 102011090092.6, filed Dec. 29, 2011, the disclosure of which is incorporated herein by reference in its entirety.

### BACKGROUND OF THE INVENTION

### FIELD OF THE INVENTION

The invention relates to a process for producing a moulding from a polyamide moulding composition wherein the moulding has improved hydrolysis resistance, and during the processing to produce the moulding, the molecular weight of the polyamide is increased and the melt stiffness of the moulding composition is increased.

Polyamides and especially polyamides having a low concentration of carbonamide groups, such as PA11 and PA12, are useful in various industrial fields due to their profile of properties. These utilities include conduits for transport of coolants in the automotive industry, and sheathing materials in the field of offshore oil production, in which a good hydrolysis resistance in particular is sought. For such applications, however, materials having even higher hydrolysis resistance, especially at relatively high temperatures, are increasingly being required.

In the extrusion of pipes, profiles and other hollow bodies, however, especially in the case of geometries with large dimensions, for reasons including gravitational force, there can be various difficulties after emergence of the body from the mould. Sagging of the emerging tubular melt is a visual sign of a low melt viscosity of the moulding composition. The force of gravity leads to a shift in the wall thicknesses, such that an irregular distribution of the wall thickness of the hollow body may occur. Moreover, the achievable geometry sizes and geometry shapes in profile extrusion are highly restricted. The melt stiffness of conventional polyamides is insufficient to allow production of the preferred geometries industrially, economically, to scale and reliably. A low melt stiffness additionally leads to an uneven, unstable extrusion profile, which may be manifested in that the melt strand runs unevenly into the calibration unit. This can lead to production faults. If the tubular melt, after leaving the die, has a sufficiently high melt stiffness, production runs much more stably and the quality of the profile becomes less sensitive to outside extrusion influences. In the case of vertical extrusion (for example a preform), the extruded tubular melt must not extend, as a result of which the wall thickness would be reduced, and must not tear either. The size of the geometries producible by this extrusion technique is currently limited by the melt stiffness of the polyamide used. In order to be able to extrude large dimensions, a high melt stiffness is required.

The extrusion of a polyamide moulding composition having high melt stiffness, however, is difficult due to high viscosity. To process high viscosity mixtures, an exceptionally high pressure buildup is needed in the machine; however, even with the use of high pressure, geometries with large dimensions cannot be produced with economically acceptable extrusion speeds, since there is a very high motor load imposed even at relatively small throughputs.

EP 1 690 889 A1 and EP 1 690 890 A1 address this problem. These applications describe a process for producing mouldings with cumulative condensation of a polyamide moulding composition with a compound having at least two carbonate units, wherein a premix is produced from the polyamide moulding composition and the compound having at least two carbonate units and the premix is then processed to give the moulding, the melting of the premix and the cumulative condensation not being effected until this step. WO 2010063568 additionally discloses that a compound having at least two carbonate groups can be used in the form of a masterbatch additionally comprising a polyetheramide wherein at least 50% of the end groups take the form of amino groups.

U.S. Pat. No. 4,128,599 states that the carboxyl end groups and, to a small degree, the amino end groups of polyamide react with polycarbodiimides, with a rise in the melt viscosity and the melt stiffness. The reaction can be conducted in an extruder; however, temperatures in the range from 250 to 300° C. and preferably 280 to 290° C. are needed. According to information from a manufacturer of carbodiimides, amino groups, however, are more reactive than carboxyl groups toward aromatic carbodiimides.

EP 0 567 884 A1 and DE 44 42 725 A1 disclose that polyamide moulding compositions can be stabilized against hydrolysis by addition of oligomeric or polymeric carbodiimides. In addition, CH 670 831 A5 teaches that, in the case of plasticizer-containing polyamide mouldings, the migration of the plasticizer may be avoided or at least greatly reduced when the mouldings comprise monomeric, oligomeric or polymeric carbodiimides.

### SUMMARY OF THE INVENTION

An object of the present invention is to provide a process to produce polyamide mouldings which are stabilized against hydrolysis and wherein the polyamide has such a high molecular weight that a higher degree of hydrolysis may be tolerated before the mechanical properties of the moulding become so poor that the moulding fails.

This and other objects have been achieved by the present invention, the first embodiment of which includes a process for producing a moulding, comprising:

mixing a polyamide having amino end groups and an oligo- or polycarbodiimide to prepare a moulding composition;

optionally, storing the prepared composition, transporting the prepared composition or storing and transporting the prepared composition; and

processing the moulding composition to obtain a moulding having cumulative condensation;

wherein

at least 50% of end groups of the polyamide are amino groups,.

a content of the oligo- or polycarbodiimide is 0.1 to 5% by weight, based on the polyamide moulding composition, and

the cumulative condensation is obtained only during the processing to form the moulding.

The term “cumulative condensation” means an increase in the molecular weight of the polyamide present in the polyamide moulding composition and hence an increase in the melt viscosity and in the melt stiffness. This may be accomplished by chain extension or by branching.

In a preferred embodiment of the present invention, the process further comprises:

preparing a masterbatch comprising the oligo- or polycarbodiimide and at least one of a polyamide and a polyetheramide; and

using the masterbatch to supply the oligo- or polycarbodiimide which is mixed with the polyamide to prepare the moulding composition.

### DETAILED DESCRIPTION OF THE INVENTION

In the first embodiment, the present invention provides a process for producing a moulding, comprising:

mixing a polyamide having amino end groups and an oligo- or polycarbodiimide to prepare a moulding composition;

optionally, storing the prepared composition, transporting the prepared composition or storing and transporting the prepared composition; and

processing the moulding composition to obtain a moulding having cumulative condensation;

wherein

at least 50% of end groups of the polyamide are amino groups,.

a content of the oligo- or polycarbodiimide is 0.1 to 5% by weight, preferably 0.2 to 2.5% by weight and more preferably 0.4 to 2.0% by weight, based on the polyamide moulding composition, and

the cumulative condensation is obtained only during the processing to form the moulding.

The term “cumulative condensation” means an increase in the molecular weight of the polyamide present in the polyamide moulding composition and hence an increase in the melt viscosity and in the melt stiffness. This may be accomplished by chain extension or by branching.

According to the present invention, the cumulative condensation is conducted during processing to form the moulding and does not occur during the mixing, storing or transportation. Therefore, the composition may be transported or stored without affecting physical properties of the composition.

In a preferred embodiment the oligo- or polycarbodiimide is prepared as a masterbatch with at least one of a polyamide and a polyetheramide; and the oligo- or polycarbodiimide is mixed with the polyamide as the masterbatch either before or during the processing to prepare the moulding.

The polyamide may be prepared with a combination of diamine and dicarboxylic acid, from an ω-amino-carboxylic acid or the corresponding lactam. In principle, it may be possible to use any polyamide, for example PA6, PA66 or copolyamides on this basis with units which derive from terephthalic acid and/or isophthalic acid (generally referred to as PPA), and also PA9T and PA10T and blends thereof with other polyamides. In a preferred embodiment, the monomer units of the polyamide may contain an average of at least 8, at least 9 or at least 10 carbon atoms. In the case of mixtures of lactams, the arithmetic mean value of carbons of the mixture would have a value of of at least 8, at least 9 or at least 10 carbon atoms. In the case of a combination of diamine and dicarboxylic acid, the arithmetic mean of the carbon atoms of diamine and dicarboxylic acid in this preferred embodiment may be at least 8, at least 9 or at least 10. Suitable polyamides may be, for example: PA610 (preparable from hexamethylenediamine [6 carbon atoms] and sebacic acid [10 carbon atoms]; the average of the carbon atoms in the monomer units here is thus 8), PA88 (preparable from octamethylenediamine and 1,8-octanedioic acid), PA8 (preparable from caprylolactam), PA612, PA810, PA108, PA9, PA613, PA614, PA812, PA128, PA1010, PA10, PA814, PA148, PA1012, PA11, PA1014, PA1212 and PA12. Methods to produce polyamides are conventionally known. It will be appreciated that it is also possible to use copolyamides based thereon, in which case it is optionally also possible to use monomers such as caprolactam.

The polyamide may also be a polyetheramide. Polyetheramides are described in DE-A 30 06 961 and contain a polyether diamine as a comonomer. Suitable polyether diamines may be obtained by converting the corresponding polyether diols by reductive amination or by coupling to acrylonitrile with subsequent hydrogenation (e.g. EP-A-0 434 244; EP-A-0 296 852). In the polyether diamine, the polyether unit may be based, for example, on 1,2-ethanediol, 1,2-propanediol, 1,3-propanediol, 1,4- butanediol or 1,3-butanediol. The polyether unit may also be of mixed structure, for instance with random or blockwise distribution of the units originating from the diols. The weight-average molar mass of the polyether diamines may be from 200 to 5000 g/mol and preferably 400 to 3000 g/mol; the proportion thereof in the polyetheramide is preferably 4 to 60% by weight and more preferably 10 to 50% by weight. Suitable polyether diamines may be obtained by conversion of the corresponding polyether diols by reductive amination or coupling to acrylonitrile with subsequent hydrogenation. Examples of commercially available polyether diamines include JEFFAMINE® D or ED products or of the ELASTAMINE® products from Huntsman Corp., or the Polyetheramine D series from BASF SE. Small amounts of a polyether triamine, for example a JEFFAMINE® T product, may optionally be included as a branched polyetheramide. In one preferred embodiment, a polyether diamine which contains an average of at least 2.3 carbon atoms per ether oxygen atom in the chain may be used.

Mixtures of different polyamides may be used, provided that the mixture components are sufficiently compatible. Compatible polyamide combinations are conventionally known and include combinations of PA12/PA1012, PA12/PA1212, PA612/PA12, PA613/PA12,-PA1014/PA12 and PA610/PA12, and corresponding combinations with PA111. Compatibility of a particular polyamide combination may be determined by routine methods known to one of skill in the art.

In one embodiment of the present invention, a mixture of 30 to 99% by weight, preferably 40 to 98% by weight and more preferably 50 to 96% by weight of polyamide, and 1 to 70% by weight, preferably 2 to 60% by weight and more preferably 4 to 50% by weight of polyetheramide, may be used.

At least 50%, preferably at least 60%, more preferably at least 70%, especially preferably at least 80% and most preferably at least 90% of the end groups of the polyamide are amino groups.

In addition to polyamide, the moulding composition may comprise further components, for example impact modifiers, other thermoplastics, plasticizers and other customary additives. The polyamide forms the matrix of the moulding composition.

Suitable impact modifiers may include, for example, ethylene/a-olefin copolymers, preferably selected from

a) ethylene/C₃- to C₁₂-α-olefin copolymers with 20 to 96% and preferably 25 to 85% by weight of ethylene. The C₃- to C₁₂-α-olefin used is, for example, propene, 1-butene, 1-pentene, 1-hexene, 1-octene, 1-decene or 1-dodecene. Typical examples thereof are ethylene-propylene rubber, and also LLDPE and VLDPE.

b) ethylene/C₃- to C₁₂-α-olefin/unconjugated diene terpolymers having 20 to 96% and preferably 25 to 85% by weight of ethylene and up to a maximum of about 10% by weight of an unconjugated dienesuch as bicyclo[2.2.1]heptadiene, 1,4-hexadiene, dicyclopentadiene or 5-ethylidenenorbornene. Suitable C₃- to C₁₂-α-olefins are likewise, for example, propene, 1-butene, 1-pentene, 1-hexene, 1-octene, 1-decene or 1-dodecene.

The preparation of these copolymers or terpolymers, for example with the aid of a Ziegler-Natta catalyst, is conventionally known.

Other suitable impact modifiers include styrene-ethylene/butylene block copolymers. In one preferred embodiment, a styrene-ethylene/butylene-styrene block copolymers (SEBS), obtained by hydrogenating styrene-butadiene-styrene block copolymers may be employed as the impact modifier. Additionally, conventionally known diblock systems (SEB) or multiblock systems, may be included as impact modifiers.

The impact modifiers may preferably contain acid anhydride groups, which are introduced in a known manner by thermal or free-radical reaction of the main chain polymer with an unsaturated dicarboxylic anhydride, an unsaturated dicarboxylic acid or an unsaturated mono-alkyl dicarboxylate in a concentration sufficient for good attachment to the polyamide. Suitable reagents for this purpose, include, for example, maleic acid, maleic anhydride, monobutyl maleate, fumaric acid, citraconic anhydride, aconitic acid or itaconic anhydride. In a preferred embodiment, from 0.1 to 4% by weight of an unsaturated anhydride may be grafted onto the impact modifier. As conventionally known, the unsaturated dicarboxylic anhydride or precursor thereof may also be grafted onto the impact modifier. The unsaturated dicarboxylic anhydride or precursor thereof may also be grafted on together with a further unsaturated monomer, for example styrene, a-methylstyrene or indene.

Other suitable impact modifiers may include copolymers which, contain units of the following monomers:

a) 20 to 94.5% by weight of one or more a-olefins having 2 to 12 carbon atoms,

b) 5 to 79.5% by- weight of one or more acrylic compounds selected from
acrylic acid or methacrylic acid or salts thereof,
esters of acrylic acid or methacrylic acid with a C1- to C12-alcohol which may optionally bear a free hydroxyl or epoxide function,
acrylonitrile or methacrylonitrile,
acrylamides or methacrylamides,

c) 0.5 to 50% by weight of an olefinically unsaturated epoxide, carboxylic anhydride, carboximide, oxazoline or oxazinone.

An impact modifier copolymer may be composed, for example, of the following monomers, though this list is not exhaustive:

a) α-olefins, for example ethylene, propene, 1-butene, 1-pentene, 1-hexene, 1-octene, 1-decene or 1-dodecene;

b) acrylic acid, methacrylic acid or salts thereof, for example with Na^{⊕} or Zn^{2⊕} as the counterion; methyl acrylate, ethyl acrylate, n-propyl acrylate, n-butyl acrylate, isobutyl acrylate, n-hexyl acrylate, n-octyl acrylate, 2-ethylhexyl acrylate, isononyl acrylate, dodecyl acrylate, methyl methacrylate, ethyl methacrylate, n-propyl methacrylate, n-butyl methacrylate, isobutyl methacrylate, 2-ethylhexyl methacrylate, hydroxyethyl acrylate, 4-hydroxybutyl methacrylate, glycidyl acrylate, glycidyl methacrylate, acrylonitrile, methacrylonitrile, acrylamide, N-methylacrylamide, N,N-dimethylacrylamide, N-ethylacrylamide, N-hydroxyethylacrylamide, N-propylacrylamide, N-butylacrylamide, N-(2-ethylhexyl)acrylamide, methacrylamide, N-methylmethacrylamide, N,N-dimethylmethacrylamide, N-ethylmethacrylamide, N-hydroxyethylmethacrylamide, N-propylmethacrylamide, N-butylmethacrylamide, N,N-dibutylmethacrylamide, N-(2-ethylhexyl)methacrylamide;

c) vinyloxirane, allyloxirane, glycidyl acrylate, glycidyl methacrylate, maleic anhydride, aconitic anhydride, itaconic anhydride, and also the dicarboxylic acids formed from these anhydrides by reaction with water; maleimide, N-methylmaleimide, N-ethylmaleimide, N-butylmaleimide, N-phenylmaleimide, aconitimide, N-methylaconitimide, N-phenylaconitimide, itaconimide, N-methylitaconimide, N-phenylitaconimide, N-acryloylcaprolactam, N-methacryloylcaprolactam, N-acryloyllaurolactam, N-methacryloyllaurolactam, vinyloxazoline, isopropenyloxazoline, allyloxazoline, vinyloxazinone or isopropenyloxazinone.

In copolymers containing glycidyl acrylate or glycidyl methacrylate, these monomers may also function as the acrylic compound b), such that no further acrylic compound need be present given a sufficient amount of the glycidyl(meth)acrylate. In this specific embodiment, the copolymer may contain units of the following monomers:

a) 20 to 94.5% by weight of one or more a-olefins having 2 to 12 carbon atoms,

b) 0 to 79.5% by weight of one or more acrylic compounds selected from
acrylic acid or methacrylic acid or salts thereof,
esters of acrylic acid or methacrylic acid with a C₁- to C₁₂-alcohol,
acrylonitrile or methacrylonitrile,
acrylamides or methacrylamides,

c) 0.5 to 80% by weight of an ester of acrylic acid or methacrylic acid which contains an epoxy group,

where the sum of b) and c) adds up to at least 5.5% by weight of the copolymer.

The copolymer may contain, small amounts of further polymerized monomers, for example dimethyl maleate, dibutyl fumarate, diethyl itaconate or styrene, provided that they do not significantly impair the properties.

The preparation of such copolymers is conventionally known. A multitude of different types thereof are available as commercial products, products of the LOTADER® series (Arkema; ethylene/acrylate/ter component or ethylene/glycidyl methacrylate).

In a preferred embodiment, the polyamide moulding composition may comprise the following components:

1. 60 to 96.5 parts by weight of polyamide,

2. 3 to 39.5 parts by weight of an impact-modifying component which contains acid anhydride groups, where the impact-modifying component is selected from ethylene/a-olefin copolymers and styrene-ethylene/butylene block copolymers,

3. 0.5 to 20 parts by weight of a copolymer which contains units of the following monomers:
a) 20% to 94.5% by weight of one or more a-olefins having 2 to 12 carbon atoms,
b) 5 to 79.5% by weight of one or more acrylic compounds selected from
   acrylic acid or methacrylic acid or salts thereof,
   esters of acrylic acid or methacrylic acid with a C₁- to C₁₂-alcohol which may optionally bear a free hydroxyl or epoxide function,
   acrylonitrile or methacrylonitrile,
   acrylamides or methacrylamides,
c) 0.5 to 50% by weight of an olefinically unsaturated epoxide, carboxylic anhydride, carboximide, oxazoline or oxazinone,

where the sum of the parts by weight of the components according to 1., 2. and 3. is 100.

In a further preferred embodiment, the moulding composition may comprise:

1. 65 to 90 parts by weight and more preferably 70 to 85 parts by weight of polyamide,

2. 5 to 30 parts by weight, more preferably 6 to 25 parts by weight and especially preferably 7 to 20 parts by weight of the impact-modifying component,

3. 0.6 to 15 parts by weight and more preferably 0.7 to 10 parts by weight of the copolymer, which preferably contains units of the following monomers:

a) 30% to 80% by weight of α-olefin(s),

b) 7 to 70% by weight and more preferably 10 to 60% by weight of the acrylic compound(s),

c) 1 to 40% by weight and more preferably 5 to 30% by weight of the olefinically unsaturated epoxide, carboxylic anhydride, carboximide, oxazoline or oxazinone.

The impact-modifying component used may additionally also be nitrile rubber (NBR) or hydrogenated nitrile rubber (H-NBR), which may optionally contain functional groups, as described in US 2003/0220449A1.

Other thermoplastics which may be present in the polyamide moulding composition include polyolefins. In one embodiment, as described above for the impact modifiers, they may contain acid anhydride groups and are then optionally present together with an unfunctionalized impact modifier. In a further embodiment, they are unfunctionalized and are present in the moulding composition in combination with a functionalized impact modifier or a functionalized polyolefin. The term “functionalized” means that the polymers are provided with groups which can react with the polyamide end groups, for example acid anhydride groups, carboxyl groups, epoxide groups or oxazoline groups. Preferred compositions include:

1. 50 to 95 parts by weight of polyamide,

2. 1 to 49 parts by weight of functionalized or unfunctionalized polyolefin and

3. 1 to 49 parts by weight of functionalized or unfunctionalized impact modifier,

where the sum of the parts by weight of components 1, 2 and 3 is 100.

The polyolefin according to this embodiment may be a commercially available polyethylene or a commercially available polypropylene. Examples include: high-, medium- or low-density linear polyethylene, LDPE, ethylene/acrylic ester copolymers, ethylene-vinyl acetate copolymers, isotactic or atactic homopolypropylene, random copolymers of propene with ethene and/or butene-1, ethylene-propylene block copolymers and the like. The polyolefin may be prepared by conventionally known processes, those according to Ziegler-Natta, the Phillips process, by means of metallocenes or by free-radical means. The polyamide in this case may also, for example, be PA6 and/or PA66.

In one preferred embodiment, the moulding composition may contain 1 to 25% by weight, more preferably 2 to 20% by weight and especially preferably 3 to 15% by weight of a plasticizer.

Plasticizers and their use in polyamides are known. A general overview of plasticizers suitable for poly-amides can be found in Gächter/Müller, Kunststoff-additive [Polymer Additives], C. Hanser publishers, 2′ edition, p. 296.

Compounds suitable as plasticizers may include, for example, esters of p-hydroxybenzoic acid having 2 to 20 carbon atoms in the alcohol component or amides of arylsulphonic acids having 2 to 12 carbon atoms in the amine component, preferably amides of benzenesulphonic acid. Useful plasticizers include ethyl p-hydroxybenzoate, octyl p-hydroxybenzoate, i-hexadecyl p-hydroxybenzoate, N-n-octyltoluenesulphonamide, N-n-butylbenzenesulphonamide or N-2-ethylhexylbenzenesulphonamide.

In addition, the moulding composition may also comprise customary amounts of additives which are required to establish particular properties. Examples thereof are pigments or fillers such as carbon black, titanium dioxide, zinc sulphide, reinforcing fibres, for example glass fibres, processing aids such as waxes, zinc stearate or calcium stearate, antioxidants, UV stabilizers and additives which impart antielectrostatic properties to the product, for example carbon fibres, graphite fibrils, fibres of stainless steel or conductive black.

The proportion of polyamide in the moulding composition is at least 50% by weight, preferably at least 60% by weight, more preferably at least 70% by weight, especially preferably at least 80% by weight and most preferably at least 90% by weight.

Oligomeric and polymeric carbodiimides are conventionally known and may be prepared by polymerization of diisocyanates. This reaction may be accelerated by catalysts and proceeds with elimination of carbon dioxide (J. Org. Chem., 28, 2069 (1963); J. Am. Chem. Soc. 84, 3673 (1962); Chem. Rev., 81, 589 (1981); Angew. Chem., 93, 855 (1981)). The reactive NCO end groups may be capped with C—H, N—H or O—H reactive compounds, for example with malonic esters, caprolactam, alcohols or phenols. Alternatively, mixtures of mono- and diisocyanates may be polymerized to obtain oligo- or polycarbodiimides having essentially unreactive end groups.

The oligo- or polycarbodiimides used in accordance with the invention have the general formula

R¹—N═C═N—(—R²—N═C═N—)ₙ—R³
where R¹ and R³=alkyl having 1 to 20 carbon atoms, cycloalkyl having 5 to 20 atoms, aryl having 6 to 20 carbon atoms or aralkyl having 7 to 20 carbon atoms, each optionally substituted by an isocyanate group optionally capped with a C—H—, an N—H— or an O—H— reactive compound;
R²=alkylene having 2 to 20 carbon atoms, cycloalkylene having 5 to 20 carbon atoms, arylene having 6 to 20 carbon atoms or aralkylene having 7 to 20 carbon atoms;
n=1 to 100, preferably 2 to 80 and more preferably 3 to 70.

The oligo- or polycarbodiimide may be a homopolymer or a copolymer, for example a copolymer of 2,4-diisocyanato-1,3,5-triisopropylbenzene and 1,3-diisocyanato-3,4-diisopropylbenzene.

Suitable oligo- and polycarbodiimides may be obtained from commercially available sources.

The oligo- or polycarbodiimide may be mixed with the polyamide moulding composition either in dry premixed form, for example in powdered form or as a pellet mixture, or it may be incorporated into the melt of the polyamide moulding composition such that there is essentially no cumulative condensation reaction. There is essentially no cumulative condensation reaction when the melt viscosity, at constant temperature and shear, increases by not more than 20%, preferably by not more than 15% and more preferably by not more than 10%. This is because the aim is to keep the motor load on the machine, for example the extruder, within the customary range during processing; a greater rise in the motor load would lead to a low processing speed, to high energy input into the melt and hence to chain degradation as a result of thermal stress and shear. If, therefore, the oligo- or polycarbodiimide is incorporated into the melt of the polyamide moulding composition prior to processing, it should be ensured that the residence time is sufficiently low and the melting temperature remains low to minimize or prevent cumulative condensation. The guide value is a maximum melting temperature of 250° C., preferably of 240° C. and more preferably of 230° C.

The processing is then preferably conducted within a temperature range between 240 and 320° C. and more preferably within the temperature range between 250 and 310° C. Under these conditions, the carbodiimide groups react sufficiently rapidly with the end groups of the polyamide. The cumulatively condensed polyamide in the moulding preferably has a corrected inherent viscosity CIV, determined to API Technical Report 17 TR2, First Edition, June 2003, Appendix D, of at least 2.0 dl/g, more preferably of at least 2.1 dl/g and especially preferably of at least 2.2 dl/g. The procedure described therein for PA11 can be generalized for all polyamides. It corresponds to ISO 307:1994, except with 20° C. in the bath rather than 25° C.

The oligo- or polycarbodiimide may preferably be metered in such that it is not consumed completely for the cumulative condensation of the polyamide in the processing. More preferably, the polyamide moulding composition of the moulding contains at least 2 meg/kg of carbodiimide groups, especially preferably at least 5 meg/kg, even more preferably at least 10 meg/kg and specifically at least 15 meq/kg or at least 20 meg/kg.

In one possible embodiment, the oligo- or polycarbodiimide is used in the form of a masterbatch in polyamide or preferably in polyetheramide. Preference is given to using a polyetheramide wherein at least 50%, preferably at least 60%, more preferably at least 70%, especially preferably at least 80% and most preferably at least 90% of the end groups consist of amino groups. This minimizes the introduction of carboxyl end groups which reduce the hydrolysis stability of the polyamide. It has been found that, surprisingly, a polyetheramide rich in amino end groups reacts only to a minor degree, if at all, with the oligo- or polycarbodiimide in the melt, i.e. in the course of production of the masterbatch and in the processing steps. The reason for the low reactivity of the amino end groups of the polyetheramide is unknown; and my possibly be due to steric hindrance.

The concentration of the oligo- or polycarbodiimide in the masterbatch may preferably be 0.15 to 40% by weight, more preferably 0.2 to 25% by weight and especially preferably 0.3 to 15% by weight. Such a masterbatch may be produced in a customary manner as known to those skilled in the art, and in one preferred embodiment the masterbatch may be prepared by mixing in the melt.

In a further preferred embodiment, the oligo- or polycarbodiimide may be first mixed with a polyamide moulding composition whose polyamide component has an excess of carboxyl end groups over amino end groups, under conditions under which essentially no reaction takes place. More than 50%, preferably at least 60%, more preferably at least 70%, especially preferably at least 80% and most preferably at least 90% of the end groups of this polyamide consist of carboxyl groups. In processing to prepare the moulding, 50 to 80% by weight and preferably 60 to 75% by weight of this mixture is then mixed in the melt together with 20 to 50% by weight and preferably 25 to 40% by weight of a polyamide moulding composition wherein the polyamide component has an excess of amino end groups over carboxyl end groups. The percentages are based here on the sum of these two components. More than 50%, preferably at least 60%, more preferably at least 70% especially preferably at least 80% and most preferably at least 90% of the end groups of this second polyamide consist of amino groups. In this embodiment, the cumulative condensation takes place primarily via the reaction of the amino end groups with the carbodiimide groups. The melt stiffness achieved can be controlled here via the amount of amino end groups. This shows that the reactivity of the amino end groups is indeed much greater than that of the carboxyl end groups. This enables addition of a higher amount of oligo- or polycarbodiimide overall, without any possibility of occurrence of an excessive buildup of melt viscosity extending as far as crosslinking in the moulding processing, in order thus to obtain a moulding having particularly good hydrolysis stability.

In a further possible embodiment, the oligo- or polycarbodiimide is used together with a further, at least difunctional, amine-reactive additive. This is preferably a compound having at least two carbonate units. Carbonate units are understood here to mean diester units of carbonic acid with alcohols or phenols. The further amine-reactive additive or the compound having at least two carbonate units is preferably used in an amount of 0.1 to 5% by weight, based on the polyamide moulding composition used, more preferably in an amount of 0.2 to 2.5% by weight and especially preferably in an amount of 0.4 to 2:0% by weight.

The compound having at least two carbonate units may have a low molecular weight or may be oligomeric or polymeric. It may consist entirely of carbonate units or it may have further units. These are preferably oligo- or polyamide, -ester, -ether, -etheresteramide or -etheramide units. Such compounds may be prepared by known oligo- or polymerization processes, or by polymer-analogous reactions.

In a preferred embodiment, the compound having at least two carbonate units is a polycarbonate, for example based on bisphenol A, or a block copolymer containing such a polycarbonate block.

Suitable compounds having at least two carbonate units are described in detail in WO 00/66650, and that description is incorporated herein by reference.

The further, at least difunctional, amine-reactive additive may preferably be metered in the form of a masterbatch. In the context of the invention, the oligo- or polycarbodiimide, and also the further, at least difunctional, amine-reactive additive, may each be used in the form of separate masterbatches. Preferably, a single masterbatch comprising both the oligo- or polycarbodimide and the further, at least difunctional, amine-reactive additive may be used.

The concentration of the amine-reactive additive or of the compound having at least two carbonate units in the masterbatch may preferably be 0:15 to 40% by weight, more preferably 0.2 to 25% by weight and especially 0.3 to 15% by weight. When the masterbatch comprises both the oligo- or polycarbodiimide and the further amine reactive additive, the total content of the two additives in the masterbatch is preferably 0.3 to 40% by weight, more preferably 0.4 to 25% by weight and especially preferably 0.6 to 15% by weight. Such a masterbatch may be produced in any conventional method known to those skilled in the art, including by mixing in the melt.

In one preferred embodiment, the polyamide moulding composition to be cumulatively condensed in the form of pellets may be incorporated with the pellets of the masterbatch. However, a pellet mixture of the ready-compounded polyamide moulding composition with the masterbatch may also be produced, then transported or stored, and processed thereafter. It is of course also possible to proceed correspondingly with powder mixtures. What is crucial is that the mixture is not melted until the processing stage. Thorough mixing of the melt in the course of processing is advisable. However, the masterbatch may equally also be metered as a melt stream, with the aid of an extruder provided, into the melt of the polyamide moulding composition to be processed, and then mixed in thoroughly. In this embodiment, mixing and processing are combined.

The melt mixture obtained by reaction of the polyamide moulding composition with the oligo- or polycarbodiimide and optionally the further amine-reactive additive is discharged and solidified. This may be accomplished, for example, in the following ways:
The melt is extruded as a profile, for example as a pipe.
The melt is shaped to a tube which is applied to a pipe for coating.
The melt is extruded as a film or sheet; and these may then optionally be monoaxially or biaxially stretched and/or wound around a pipe fitting. The film or sheet may also be thermoformed prior to further processing.
The melt is extruded to preforms which are then shaped in a blow-moulding process.
The melt is processed in an injection moulding process to give a moulding.

The mouldings produced in accordance with the invention may be, in one embodiment, hollow bodies or hollow profiles, especially with large diameters, for example liners, gas conduit pipes, layers of offshore pipelines, subsea pipelines or supply pipelines, refinery pipelines, hydraulic conduits, chemical conduits, cable ducts, filling station supply conduits, ventilation conduits, air intake pipes, tank filling stubs, coolant conduits, reservoir vessels and fuel tanks. Such mouldings are producible, for example, by extrusion, coextrusion or blow-moulding, including suction-blow-moulding, 3-D blow-moulding, pipe insert and pipe manipulation processes as are conventionally known.

The walls of these hollow bodies or hollow profiles here may either have one layer and, in this case, consist entirely of the moulding composition processed according to the present invention, or alternatively, have more than one layer, in which case the moulding composition processed in accordance with the invention may form the outer layer, the inner layer and/or the middle layer. The wall may consist of a multitude of layers; the number of layers being determined by the requirements of the intended end use. The other layer(s) consists(s) of moulding compositions based on other polymers, for example polyethylene, polypropylene, fluoropolymers, or of metal, for example steel. For example, the flexible conduits used for offshore pipelines are of multilayer structure; they generally consist of a steel structure comprising at least one polymer layer and generally at least two polymer layers. Such “unbonded flexible pipes” are described, for example, in WO 01/61232, U.S. Pat. No. 6,123,114 and U.S. Pat. No. 6,085,799; they are additionally characterized in detail in API Recommended Practice 17B, “Recommended Practice for Flexible Pipe”, 3rd Edition, March 2002, and in API Specification 17J, “Specification for Unbonded Flexible Pipe”, 2nd Edition, November 1999. The term “unbonded” in this context means that at least two of the layers, including reinforcement layers and polymer layers, are not bonded to one another by construction means. In practice, the pipe comprises at least two reinforcement layers which are bonded to one another neither directly nor indirectly, i.e. over further layers, over the pipe length. As a result, the pipe becomes pliable and sufficiently flexible to roll it up for transport purposes. The polymer layers firstly assume the function of sealing the tube, such that the transported fluid cannot escape, and secondly, when the layer is on the outside, the function of protecting the steel layers from the surrounding seawater. The polymer layer which provides sealing against the transported fluid, in one embodiment, is extruded on an internal carcass. This polymer layer, frequently also called barrier layer, may, as described above, consist in turn of a plurality of polymer layers.

The use of polyetheramide in the masterbatch or in the polyamide moulding composition used may advantageously increase the flexibility of the moulding composition such that it may be possible to dispense with further plasticization by external plasticizers. This may be advantageous such that, even on contact with highly extractive media, for example supercritical carbon dioxide, the material properties of the moulding remain constant.

In the case of additional use of a compound having at least two carbonate units, a particularly efficient molecular weight increase of the polyamide is first achieved; secondly, it is ensured in this way that the reaction of the oligo- or polycarbodiimide with the amino end groups of the polyamide is suppressed and, in this way, a sufficient proportion of unreacted carbodiimide groups remains within the product.

Having generally described this invention, a further understanding can be obtained by reference to certain specific examples which are provided herein for purposes of illustration only, and are not intended to be limiting unless otherwise specified.

### EXAMPLES

### Examples 1 and 2 and Comparative Example 1

First of all, the following compounds were produced:

Compound 1: 100 parts by weight of a PA12 having an excess of carboxyl end groups (VESTAMID® X1852) were mixed, extruded and pelletized in a twin-screw kneader at 220° C. with 2 parts by weight of Stabaxol P 400 (polycarbodiimide from Rhein Chemie Rheinau GmbH, Mannheim).

Compound 2: 100 parts by weight of VESTAMID® X1852 were mixed, extruded and pelletized in a twin-screw kneader at 220° C. with 2 parts by weight of Stabaxol P 400 and 1.5 parts by weight of Brüggolen M1251, a chain extender for polyamides, which consists of a mixture of low molecular weight polycarbonate and PA6 (L. Brïggemann K G, Heilbronn, Germany).

Compound 3 (comparative): 100 parts by weight of VESTAMID® 1852 were mixed, extruded and pelletized in a twin-screw kneader at 220° C. with 1.5 parts by weight of Brüggolen M1251.

Compound 4: VESTAMID® ZA7295, a PA12 having an excess of amino end groups. The reactive components (compound 1, compound 2, compound 3) were each mixed as pellets in a ratio of 1:3 with compound 4. These pellet mixtures were used to extrude 10×1 pipes (external diameter 10 mm, wall thickness 1 mm) and these were supplied to the hydrolysis test at 120° C. The results are shown in table 1.

TABLE 1

| | | | | Comparative |
|---|---|---|---|---|
| | | Example 1 | Example 2 | example 1 |
| Compound 1 [parts by weight] | | 25 | | |
| Compound 2 [parts by weight] | | | 25 | |
| Compound 3 [parts by weight] | | | | 25 |
| Compound 4 [parts by weight] | | 75 | 75 | 75 |
| CIV [dl/g] after storage | 0 | 1.922 | 2.571 | 1.900 |
| time [d] | 4 | 1.906 | 2.507 | 1.793 |
| | 10 | 1.705 | 2.078 | 1.521 |
| | 17 | 1.487 | 1.722 | 1.301 |
| | 24 | 1.344 | 1.501 | 1.184 |
| | 41 | 1.166 | 1.258 | 1.071 |
| | 59 | 1.127 | 1.188 | 1.056 |
| | 80 | 1.098 | 1.142 | 1.054 |

### Examples 3 and 4 and Comparative Example 2:

First of all, the following compounds were produced:

Compound 5: 100 parts by weight of a polyetheramide with PA12 hard blocks and 43% by weight of soft blocks based on polyetherdiamine-and having a molecular weight of about 2000 were mixed, extruded and pelletized in a twin-screw kneader at 220° C. with 3 parts by weight of Stabaxol P 400.

Compound 6: 100 parts by weight of the same polyetheramide were mixed, extruded and pelletized in a twin-screw kneader at 220° C. with 3 parts by weight of Stabaxol P 400 and 3 parts by weight of Brüggolen M1251.

Compound 7 (comparative): 100 parts by weight of the same polyetheramide were mixed, extruded and pelletized in a twin-screw kneader at 220° C. with 3 parts by weight of Brüggolen M1251.

The reactive components (compound 5, compound 6 and compound 7) were each mixed as pellets in a ratio of 15:85 with compound 4. These pellet mixtures were used to extrude 10x 1 pipes; the melt-shear curves were subsequently determined on the pipe material (plate-plate PP25 (h=1.0 mm), T 240° C.). According to this, a clear increase in viscosity took place during the extrusion process, and particularly the combination of Stabaxol and Brüggolen led to a very high melt stiffness and particularly melt strength, which is needed for the extrusion of large pipes. The results are shown in table 2.

In the subsequent hydrolysis tests on these pipes, a distinct advantage was detected for the use of Stabaxol, especially also in combination with Brüggolen M1251, at two different temperatures (100° C. and 120° C.); see table 2.

TABLE 2

| | | | | Comparative |
|---|---|---|---|---|
| | | Example 3 | Example 4 | example 2 |
| Compound 5 [parts by weight] | | 15 | | |
| Compound 6 [parts by weight] | | | 15 | |
| Compound 7 [parts by weight] | | | | 15 |
| Compound 4 [parts by weight] | | 85 | 85 | 85 |
| Viscosity [Pas] at cycle | 0.1 | 88447 | 482000 | 22398 |
| frequency [l/s] | 0.15849 | 75420 | 387000 | 22400 |
| | 0.25119 | 62479 | 302000 | 21217 |
| | 0.39811 | 50526 | 222000 | 19474 |
| | 0.63096 | 39808 | 161000 | 17292 |
| | 1 | 30853 | 116000 | 15113 |
| | 1.58489 | 23664 | 82690 | 12995 |
| | 2.51189 | 18042 | 59241 | 11085 |
| | 3.98107 | 13751 | 42879 | 9416 |
| | 6.30957 | 10524 | 31295 | 7955 |
| | 10 | 8105 | 22912 | 6691 |
| | 15.8489 | 6279 | 16768 | 5590 |
| | 25.1189 | 4833 | 12236 | 4626 |
| | 39.8107 | 3802 | 8879 | 3780 |
| | 63.0957 | 2959 | 6405 | 3050 |
| | 100 | 2289 | 4577 | 2418 |
| | 158.489 | 1759 | 3253 | 1887 |
| | 251.189 | 1342 | 2298 | 1454 |
| | 398.107 | 1025 | 1636 | 1116 |
| CIV [dl/g] after | 0 | 2.136 | 2.417 | 1.892 |
| storage time | 24 | 2.227 | 3.113 | 1.769 |
| at 100° C. | 50 | 1.913 | 2.457 | 1.503 |
| | 101 | 1.514 | 1.821 | 1.193 |
| | 199 | 1.225 | 1.29 | 1.008 |
| at 120° C. | 0 | 2.136 | 2.417 | 1.892 |
| | 7 | 2.058 | 2.931 | 1.66 |
| | 14 | 1.724 | 2.294 | 1.389 |
| | 30 | 1.288 | 1.529 | 1.065 |
| | 51 | 1.103 | 1.174 | 0.974 |
| | 70 | 1.054 | 0.967 | 0.982 |

Numerous modifications and variations on the present invention are possible in light of the above teachings. It is therefore understood that within the scope of the appended claims, the invention may be practiced otherwise than as specifically described herein.

1. A process for producing a moulding, comprising:
mixing a polyamide having amino end groups and an oligo- or polycarbodiimide to prepare a moulding composition;
optionally, storing the prepared composition, transporting the prepared composition or storing and transporting the prepared composition;
processing the moulding composition to obtain a moulding having cumulative condensation;
wherein
at least 50% of end groups of the polyamide are amino groups,.
a content of the oligo- or polycarbodiimide is 0.1 to 5% by weight, based on the polyamide moulding composition, and
the cumulative condensation is obtained only during the processing to form the moulding.

2. The process according to claim 1, further comprising:
preparing a masterbatch comprising the oligo- or polycarbodiimide and at least one of a polyamide and a polyetheramide; and
using the masterbatch to supply the oligo- or polycarbodiimide which is mixed with the polyamide to prepare the moulding composition.

3. The process according to claim 2,
wherein
a concentration of the oligo- or polycarbodiimide in the masterbatch is from 0.15 to 40% by weight of the masterbatch.

4. The process according to claim 1, further comprising:
adding an at least difunctional, amine-reactive compound to the moulding composition;
wherein
a content of the difunctional amine-reactive based on the weight of the moulding composition is from 0.1 to 5% by weight.

5. The process according to claim 2, further comprising:
adding an at least difunctional, amine-reactive compound to the masterbatch in a content of 0.15 to 40% by weight, based on the weight of the masterbatch.

6. The process according to claim 4,
wherein the at least difunctional, amine-reactive additive is a compound having at least two carbonate units.

7. The process according to claim 5,
wherein the at least difunctional, amine-reactive additive is a compound having at least two carbonate units.

8. The process according to claim 2,
wherein
the moulding composition is in a form of pellets, and
the masterbatch is in a form of pellets.

9. The process according to claim 2,
wherein
the masterbatch as a melt stream is mixed into a melt of the polyamide moulding composition, and
the melt mixture is processed.

10. The process according to claim 9, wherein a processing temperature is from 240° C. to 320 ° C.

11. The process according to claim 1,
wherein
a corrected inherent viscosity, CIV, of the polyamide in the moulding is at least 2.0 dl/g as determined according to API Technical Report 17 TR2, First Edition, June 2003, Appendix D.

12. The process according to claim 1, wherein the polyamide moulding composition of the moulding comprises at least 2 meq/kg of carbodiimide groups.

13. The process according to claim 1, wherein the oligo- or polycarbodiimide is in a masterbatch comprising a polyetheramide having at least 50% amino end groups.

14. The process according to claim 1, wherein the oligo- or polycarbodiimide is of formula
R¹—N═C═N—(—R²—N═C═N—)ₙ—R³
wherein
R¹ and R³ are alkyl having 1 to 20 carbon atoms, cycloalkyl having 5 to 20 atoms, aryl having 6 to 20 carbon atoms or aralkyl having 7 to 20 carbon atoms, each optionally substituted by an isocyanate group optionally capped with a C—H—, an N—H— or an O—H— reactive compound;
R² is alkylene having 2 to 20 carbon atoms, cycloalkylene having 5 to 20 carbon atoms, arylene having 6 to 20 carbon atoms or aralkylene having 7 to 20 carbon atoms;
n is 1 to 100.

15. The process according to claim 1, wherein a temperature of the moulding composition is less than 250° C. prior to processing to obtain the moulding.

16. The process according to claim 1, wherein the polyamide having amino end groups comprises at least one further component.

17. The process according to claim 16, wherein the at least one further component is selected from the group consisting of an impact modifier, another thermoplastic polymer and a plasticizer.

18. The process according to claim 1, wherein the moulding is a hollow body or hollow profile.

19. A hollow body or a hollow profile obtained by the process according to claim 1.

20. The hollow body or hollow profile according to claim 19, wherein the hollow body or hollow profile is a large diameter unit selected from the group consisting of a gas conduit pipe, a layer of an offshore pipeline, a subsea pipeline, a supply pipeline, a refinery pipeline, a hydraulic conduit, a chemical conduit, a cable duct, a filling station supply conduit, a ventilation conduit, an air intake pipe, a tank filling stub, a coolant conduit, a reservoir vessel and a fuel tank.
